(19) United States
(12) Patent Application Publication
(10) Pub. No.: US 2018/0111721 A1
(43) Pub. Date: Apr. 26, 2018

(54) Multiple Bags Within A Bag

(71) Applicant: Dorian Alexander Robinson, Wilmington, NC (US)

(72) Inventor: Dorian Alexander Robinson, Wilmington, NC (US)

(21) Appl. No.: 15/334,189

(22) Filed: Oct. 25, 2016

(51) Int. Cl. B65D 33/00; B65F 1/00; B65D 33/28; B65F 1/06; B65F 1/14; B65D 75/52

(52) U.S. Cl. CPC B65D 33/001; B65F 1/0006; B65D 75/527; B65F 1/062; B65F 1/14; B65D 33/28

(57) ABSTRACT

A bag includes multiple bags nested within it. The bags may be sealed together along the open edge to eliminate slippage before use. When bags are ready for use, the seal may be broken to allow removal of each bag separately.

The common practice of taking out the trash requires the undesirable task of replacing a full trash bag with an empty trash bag. The frequency of this task can be reduced by placing multiple trash bags at once, in the trash can structure. When a bag is removed, the remaining layers stay in the structure awaiting use.

### FIELD OF THE INVENTION

The invention relates generally to the field of bags. More particularly, the invention relates to a bag placed inside of a bag, placed inside of another bag, recurring. Not only reducing the frequency of necessary bag replacement, but also the possibility of more strength and durability in a single use by use of more than one bag at once, if desired.

### BACKGROUND OF THE INVENTION

It is common practice to place a plastic bag inside of a waste basket, trash can, or other structure where a bag is applicable to be filled with material. When the bag is filled, the bag is removed from the structure. This creates the undesirable task of having to replace the bag multiple times. The present invention is designed to reduce the number of times the task of replacing a bag must be completed.

### SUMMARY OF THE INVENTION

The present invention is composed of a bag within a bag, recurring until desired number of layers is achieved. Layers joined by a breakable seal located near the top edge of the bag.

By utilizing multiple bags during one bag replacement session, the frequency of required bag replacements is reduced.

The seal can be broken when bag separation is desired.

### DETAILED DESCRIPTION

A bag is to be defined to include, but is not limited to a plastic (or other flexible material) bag, tote, container, sack, pouch, duffel. Material is to be defined to include, but is not limited to, trash, waste, garbage, goods, groceries, provisions. Seal is to be defined to include, but is not limited to, perforated seal, crease, zipper, peal strip. Nested is defined to include, but is not limited to layered, multiple within one another, planted, inserted, entrenched.

Bags are packaged in combined sets. For example, when used as a trash bag liner, a pack of 50 bags may include 10 sets of 5 bags layered or 5 sets of 10 bags layered. A set of bags is placed inside of a waste basket, trash can, or other structure where lining is applicable to be filled with material. This placement usually involves the closed end of the bags inserted to the bottom of the structure, while the open edge of the bags is folded over the top edge of the structure. The bags are combined by a breakable seal near the top edge of the bags. The seal can be broken before or after the bag is filled. The seal may be used in conjunction with bags that feature a drawstring by placing the seal above the drawstring portion of the bags. When bag removal is desired, the exposed bag layer (along with lower layers, if desired) is unfolded from the top edge of the structure and removed from the structure, leaving the remaining layers of the set in the structure, awaiting filling. The inconvenient task of replacing a bag will only need to be completed a fraction of the times that a bag is removed, due to the use of a set of nested bags.

### BRIEF DESCRIPTION OF DRAWINGS

FIG. 1. Is a perspective view of a combined set of nested bags.

FIG. 2. Is a perspective view of a set of nested bags after seal has been removed.

### DETAILED DESCRIPTION OF DRAWINGS

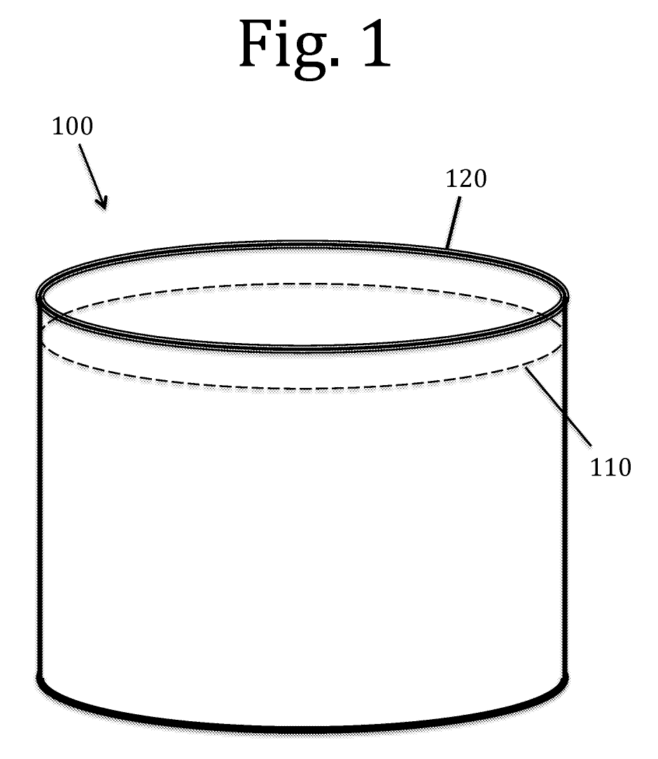

Referring to FIG. 1, illustrated is a set of nested bags 100 that is suitable for use as a liner of a trash receptacle or other structure. In this rendering, the bags are combined by a breakable, perforated seal 110 near the top of the bags. In this rendering, the top edge of each bag 120 in the set is visible prior to the seal 110 being broken.

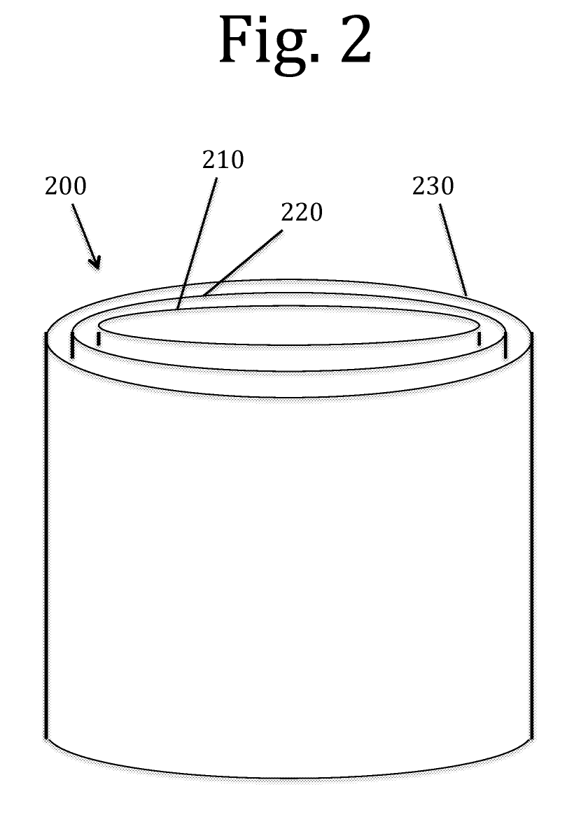

Referring to FIG. 2, illustrated is a set of 3 nested bags suitable for use as a liner of a trash receptacle or other structure with no seal 110 illustrated in FIG. 1 remaining. Each bag from the set, 210, 220, 230, is capable of holding the same amount of material and has the ability to be removed independently from the next layer of the set, if desired.

What is claimed:

1. The packaging of bags within one another to reduce frequency of bag replacement.

2. A removable seal along the top edge of a set of bags, combining the layers.
